(19) United States
(12) Patent Application Publication
(10) Pub. No.: US 2011/0232407 A1
(43) Pub. Date: Sep. 29, 2011

(54) HELICAL GEARING

(76) Inventors: Armin Verhagen, Schwieberdingen (DE); Willi Nagel, Remseck/Hochdorf (DE); Bernd Goetzelmann, Rutesheim (DE)

(21) Appl. No.: 13/120,617

(22) PCT Filed: Jul. 27, 2009
(86) PCT No.: PCT/EP09/59634

§ 371 Date: Mar. 23, 2011

(30) Foreign Application Priority Data
Sep. 23, 2008 (DE) 102008042299.1

(51) Int. Cl. F16H 25/22

(52) U.S. Cl. 74/424.93

(57) ABSTRACT

The invention relates to helical gearing having a spindle and a counterpart, which engages on a thread of the spindle. The counterpart is, for example, tube-shaped, encloses the spindle concentrically, and has rollers on the inside of the counterpart which roll on thread flanks of the thread. By rotation of the spindle, the counterpart is driven like the nut of a spindle drive. The thread of the helical gearing according to the invention is provided with a changing pitch and thus a changing gear ratio.

### PRIOR ART

The invention relates to a helical gearing with the defining characteristics of the preamble to claim 1.

DE 602 22 101 T2 has disclosed a helical gearing with a spindle and a nut placed thereon. When the spindle is driven to rotate, the nut is slid in the axial direction. To this extent, the known helical gearing corresponds to conventional helical gearings. The nut of the known helical gearing has two opposing shaft stubs protruding radially outward on which rollers are supported in rotary fashion. The rollers engage in slots in a sleeve that coaxially encompasses the nut and the spindle. One section of the slots extends in the longitudinal direction of the helical gearing, i.e. in an axially parallel fashion, and at one end, the slots transition into a curved path that ends with a radial path, i.e. one that is transverse to the helical gearing. The sleeve is situated in stationary fashion and the rollers of the nut roll against flanks of the slots in the sleeve. If the rollers of the nut of the known helical gearing are situated in the axially parallel sections of the slots of the sleeve, then the nut is secured in a rotationally fixed fashion and slides in accordance with the thread pitch when the spindle is rotated. This, too, corresponds to conventional helical gearings. If the rollers of the nut travel into the curved sections of the slots, then the nut rotates, with the rotation of the nut coinciding with the rotation of the spindle so that the sliding motion of the nut decreases or increases depending on whether the slots are curved in the thread direction of the spindle or opposite from it. As a result, the apparent pitch of the screw thread changes; it is possible to produce a higher axial force of the nut with a given torque or conversely, it is possible to produce a higher sliding speed with a given rotation speed of the spindle. An apparent multiplication of the helical gearing changes; the expression “apparent multiplication” is understood to mean the ratio of the sliding speed of the nut relative to the rotation speed of the spindle.

It should be noted that these are movements of the nut relative to the spindle. Instead of driving the spindle to rotate, it is also possible to drive the nut and the sleeve encompassing it to rotate, thus causing a sliding motion of the spindle. It is also possible to slide the spindle or nut in order to produce a rotary motion of the respective other part, i.e. of the nut with the sleeve or of the spindle.

### DISCLOSURE OF THE INVENTION

The helical gearing according to the invention, with the defining characteristics of claim 1 has a thread, for example on a threaded spindle. The thread is engaged by a counterpart component instead of a nut. For this purpose, the counterpart component has, for example, a pin, a sliding block, a rolling component such as a roller, or the like, which rests against a thread flank of the thread. A contact with a thread flank is sufficient if an advancing motion is only supposed to occur in one direction, i.e. the helical gearing is always loaded in the same direction. For a bidirectional drive, the engagement of the counterpart component with the thread must occur at two thread flanks facing toward or away from each other. In other words, a convolution can be embodied in the form of a groove, for example, in which a roller of the counterpart component engages. The two grooves flanks are composed of thread flanks facing toward each other; the roller of the counterpart component rolls along one of the two thread flanks depending on the rotation direction of the thread. The counterpart component is driven in two directions. The counterpart component can also have two rollers between which is situated a raised convolution of the thread so that the rollers roll along two thread flanks of the thread facing away from each other. The counterpart component in this case is likewise driven in two directions. The engagement with the thread can also occur by means of sliding instead of rolling, for example by means of a pin or a sliding block of the counterpart component.

According to the invention, the thread of the helical gearing has a changing pitch, thus changing a multiplication of the helical gearing. The multiplication of the helical gearing is the ratio of the sliding motion of the counterpart component to the rotation (angle of rotation) of the thread. As explained in connection with the prior art, the counterpart component can be driven to rotate and the thread can thus be slid or a sliding of the thread or counterpart component can be converted into a rotation of the respective other part.

The pitch of the thread of the helical gearing according to the invention can essentially change in any way; in other words, it can increase and then decrease again, for example. It is also possible for some sections to have a pitch of zero or even for some sections to have a negative pitch which means that the thread pitch reverses, i.e. a right-hand thread has one or more sections embodied in the form of left-hand threads. The sliding motion of the counterpart component with reference to the thread reverses in these sections.

As mentioned above, the advantage of the helical gearing according to the invention is the changing multiplication. It is thus possible in some sections of the thread to achieve a powerful axial force with a given torque and in other sections of the thread, to achieve a high sliding speed with a given rotation speed. It is not absolutely necessary for a spindle to be equipped with the thread; it is also conversely possible for the counterpart component to be embodied, for example, in the form of a sleeve equipped with an internal thread that is engaged by a pin, a sliding block, a roller, or the like belonging to a rod or other component that extends through the sleeve. The function of the helical gearing does not change as a result of this; naturally, the design changes as a result, but the design principle underlying the present invention is retained.

Advantageous embodiments and modifications of the invention disclosed in claim 1 are the subject of the dependent claims.

With a multi-start thread (claim 3), for each convolution, the counterpart component preferably has a pin, a sliding block, a rolling element, or a similar element, which engages the respective convolution (claim 4). With two convolutions, the counterpart component can be driven in a moment-free fashion; a moment is understood here to be an imaginary axis radial to the helical gearing, i.e. a tilting moment around the transverse axis of the counterpart component. With three convolutions, the engagement of the counterpart component with the thread is statically defined.

Claim 5 provides a spring element that is placed under stress when the counterpart component is slid in one direction relative to the thread and is allowed to relax when the counterpart component is slid in the opposite direction. In other words, energy is stored in the spring element with a sliding motion in one direction and (disregarding losses) the spring element then gives back this energy with a sliding motion in the opposite direction. The spring element can be prestressed so that it always exerts a spring force on the counterpart component. Also according to claim 5, the thread pitch increases with the decrease in the spring force or prestressing due to the deforming of the spring element, i.e. due to the sliding motion of the counterpart component relative to the thread. The multiplication of the helical gearing thus increases with the decrease in the spring force of the spring element. The subject of claim 5 intrinsically comprises an actuating device that exerts a force or moment. In the opposite movement direction, stress or more stress is placed on the spring element, i.e. energy is stored in it. The actuating device can also be referred to as an actuator. It permits the use of a comparatively low-powered drive unit since part of the force that the actuating device exerts is exerted by the stressed spring element. To accomplish this, the drive unit must actively reset the actuating device, i.e. must place stress on the spring element again after the actuation in order to once again store the previously output energy. As explained previously, the actuating device can exert a force or moment. Aside from a linearly acting spring element such as a compression or tension spring, the actuating device can also have a spring element that exerts a moment, for example a spiral spring.

An actuating device of the kind explained in the preceding paragraph can also have a thread with a constant pitch (claim 7).

Claim 10 provides a brake with which it is possible to fix the helical gearing in any position. For example, it is possible to use an electromagnetic brake that is actuated, i.e. applied, when without current. It is possible to use brakes or clutches that engage in a nonpositive, frictional way or in a form-locked way.

The helical gearing according to the invention can also be used as a variable damper; this is the subject of claim 12. The damping occurs through braking of the rotation of the thread and/or through braking of the sliding motion of the counterpart component. The braking can be carried out by means of a brake or for example also by means of a motor. For example, an electric motor can be operated as a generator or also in so-called four-quadrant operation, i.e. can be selectively operated as a motor and as a generator in order to produce a desired variable damping. As provided here, the motor or a drive unit in general acts in opposition to a load. It is also possible to use a hydraulic motor, hydraulic cylinder, or other drive unit to execute a variable damping and, as needed, a driving function. The helical gearing according to the invention can also be used as an energy storage device.

### BRIEF DESCRIPTION OF THE DRAWINGS

The invention will be explained below in conjunction with exemplary embodiments shown in the drawings.

FIG. 1 shows an axial section through a helical gearing according to the invention;

FIG. 2 shows an axial section through an actuator with a helical gearing according to the invention;

FIG. 3 shows an axial section through another actuator with a helical gearing according to the invention; and

FIG. 4 shows a developed view of a convolution of a helical gearing according to the invention.

Other defining characteristics of the invention ensue from the following description of embodiments of the invention in connection with the claims, the preceding description, and the drawings. The individual features can each be embodied separately or can be embodied several at a time in any combination in the embodiments of the invention.

### EMBODIMENTS OF THE INVENTION

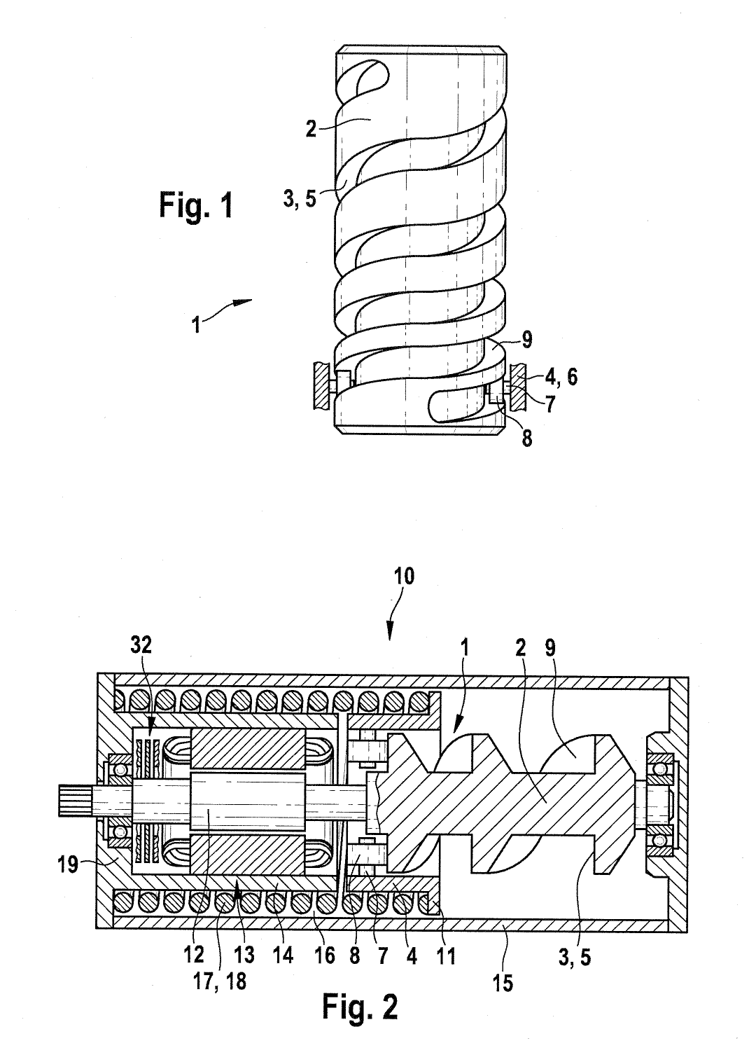

The helical gearing 1 according to the invention shown in FIG. 1 has a spindle 2 with a thread 3 and a counterpart component 4 that engages with the thread 3. The counterpart component 4 functions essentially like a nut; it is slid axially when the spindle 2 is driven to rotate.

Convolutions 5 of the thread 3 are embodied in the form of helical grooves; other cross-sections of the convolutions 4 are also possible; for example, the convolutions can also be raised, as depicted in FIG. 2. The specific feature is the fact that the thread 3 has a changing pitch and the thread pitch increases in one direction.

The counterpart component 4 has a sleeve 6 that encompasses the spindle 2 concentrically. Shaft stubs 7 protrude inward from the sleeve 6 and support rolling elements embodied in the form of rollers 8 in rotary fashion. The rollers 8 engage in the convolutions 5, which are embodied in the form of grooves; when the spindle 2 rotates, the rollers 8 roll along thread flanks 9 of the convolutions 5, i.e. of the thread 3. For each convolution 5, the counterpart component 4 has one roller 8, which engages in the convolution 5 or in other words, engages with the thread 3.

Through rotation of the spindle 2, the counterpart component 4 is slid axially relative to the spindle 2; in the process of this, as a result of the changing thread pitch, the sliding speed of the counterpart component 4 changes with a constant rotation speed of the spindle 2. Also due to the changing thread pitch, a change occurs in the axial force with which the counterpart component 4 is slid with a constant driving moment of the spindle 2.

Naturally, the kinematic reverse is also possible: the counterpart component 4 can be driven to rotate, thus sliding the spindle 2 relative to the counterpart component 4. It is also possible to slide the spindle 2 or counterpart component 4 axially relative to the respective other part 4, 2, thus setting the respective other part, i.e. the counterpart component 4 or the spindle 2 into rotation. The prerequisite for the conversion of a sliding motion into a rotating motion is a sufficiently high thread pitch that avoids a self-locking. A comparatively low thread pitch is sufficient for this purpose due to the rolling support of the engagement of the counterpart component 4 with its rollers 8 in the thread 3.

The rolling support of the thread engagement is not absolutely required; a sliding support is also possible, for example by having the shaft stubs 7 of the counterpart component 4, embodied in the form of pins, engage in the convolutions 5 (not shown). The changing thread pitch changes a multiplication of the helical gearing 1.

Basically, it is sufficient for there to be a single-start thread 3 that the counterpart component 4 engages at one location, i.e. a thread 3 with one convolution 5, in which the counterpart component 4 engages with a roller 8 (not shown). In the embodiment of the invention shown in FIG. 1, the thread 3 is a two-start thread, i.e. has two convolutions 5 that are engaged by two rollers 8 situated opposite each other. This achieves a symmetrical drive of the counterpart component 4 and prevents a tilting moment of the counterpart component 4. A three-start thread 3 in which the counterpart component 4 engages at three locations distributed uniformly or non-uniformly around the circumference would support the counterpart component 4 in a statically defined way (not shown).

In FIG. 2, a helical gearing 1 is integrated into an actuator 10. The actuator 10 can also be referred to as an actuating device. As in FIG. 1, the thread 3 has a changing thread pitch. By contrast with FIG. 1, in FIG. 2, the convolutions 5 are raised and the thread 3 here has a saw-toothed profile. The counterpart component 4 is tubular and has an outward-protruding radial flange 11. Rollers 8 of the counterpart component 4 roll along a radial thread flank 9 of the thread 3 with the saw-toothed profile. A spring element 17, which is supported against an end wall 19 of an actuator housing 15, presses against the radial flange. 11 of the counterpart component 4 so that the rollers 8 always roll against the radial thread flank 9 of the thread 3 and do not lift away from the thread flank 9.

The spindle 2 of the helical gearing 1 is rigidly connected to a motor shaft 12 of an electric motor 13; it can be of one piece with the motor shaft 12. In order to reduce the centrifugal mass, the spindle 2 and/or the motor shaft 12 can be hollow (not shown). In addition, the rollers can be situated on the motor shaft or on a shaft extending the motor shaft and can roll along internal convolutions of the counterpart component (not shown). Instead of the spindle 2 being rotationally fixed relative to the motor shaft 12, a (reducing) transmission can be situated between the electric motor 13 and the helical gearing 1. The term “between” does not absolutely refer to the spatial location of such a transmission, but to its location with regard to the transmission of moment. A planetary gear arrangement is suitable for this due to its compact design.

The spindle 2 and the motor shaft 12 are coaxial to each other. The electric motor 13 has a tubular motor housing 14 that is situated coaxially in the tubular actuator housing 15. A diameter of the actuator housing 15 is greater than a diameter of the motor housing 14, leaving an annular gap 16 between the actuator housing 15 and motor housing 14 in which gap the spring element 17 is accommodated. In FIG. 2, the spring element 17 is embodied in the form of a helical compression spring 18.

When the electric motor 13 drives the spindle 2 to rotate, this causes the counterpart component 4 to move in a sliding fashion. The thread pitch increases as the distance from the electric motor 13 increases, i.e. with a relaxing of the spring element 17. In order to output a torque, the electric motor 13 is supplied with current and the motor shaft 12 is consequently driven to rotate. The rotation and torque can be output from the motor shaft 12. The rotation is assisted by the spring element 17, which presses against the counterpart component 4 and exerts a torque on the spindle 2 via the helical gearing 1. The electric motor 13 consequently exerts only part of the torque that the actuator 10 outputs. The torque output by the actuator 10 can generally be understood to be an external load or a reaction moment to an external load that acts on the motor shaft 12 in the form of a moment external to the actuator housing 15. In order to return to the starting position, the electric motor 13 is operated in the opposite rotation direction. As a result, it exerts stress on the spring element 17 via the helical gearing 1, thereby storing energy in the spring element 17, which is subsequently output once more in a rotary drive mode. The returning motion is carried out actively by the electric motor 13, which as described above, must exert a torque in order to exert stress on the spring element. If the external load is also active in the returning action, then it assists the returning action. In this case, the electric motor 13 exerts only part of the moment that is required to exert stress on the spring element 17. In a stopping of the external load, the spring element 17 assists the electric motor 13 thereby reducing its current consumption and thermal load.

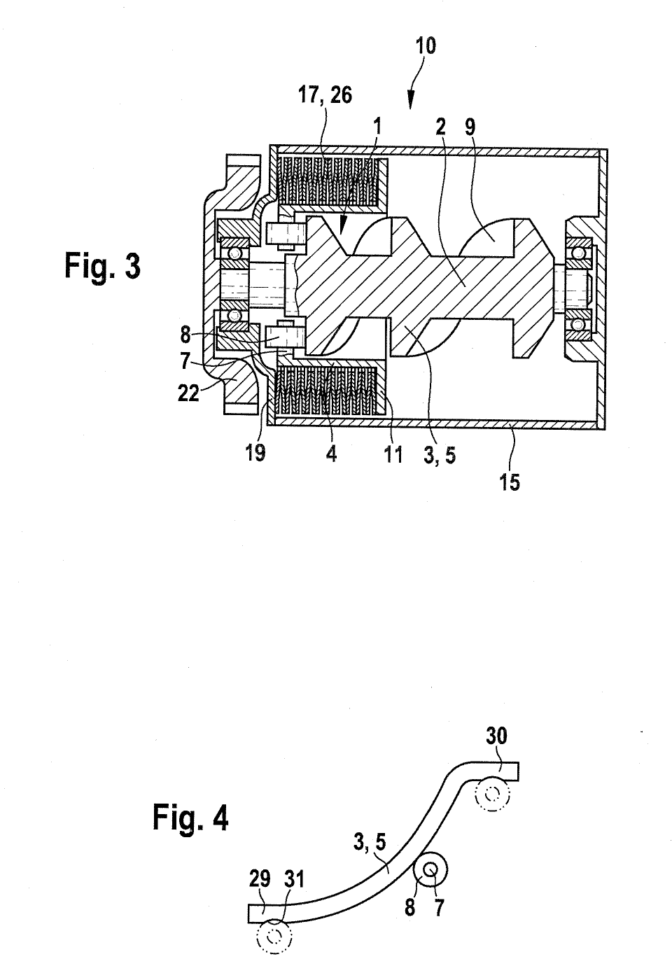

FIG. 3 shows another actuator 10 with a helical gearing 1 according to the invention, whose thread pitch changes. The helical gearing 1 is accommodated in an actuator housing 15. The spindle 2 of the helical gearing 1 is embodied as shown in FIG. 2; it has convolutions 5 with a saw-toothed profile, along which rollers 8 of the tubular counterpart component 4 roll. The actuator 10 from FIG. 3 has no electric motor; to drive the spindle 2 to rotate, a gear 22 is mounted in a rotationally fixed fashion on one end of the spindle 2. The actuator 10 shown in FIG. 3 has a spring element 17 embodied in the form of a spring washer stack 26, which is situated in an annular gap between the tubular counterpart component 4 and the tubular actuator housing 15. The spring washer stack 26 is supported against an end wall 19 of the actuator housing 15 and presses against a radial flange 11 that protrudes outward from the counterpart component 4.

The actuator 10 from FIG. 3 has a high power density and a compact design. The dispersed design with a separate drive motor permits a freer physical arrangement. For example, an electric drive motor can be situated in parallel fashion next to the actuator 10 or radial to it. The actuator 10 from FIG. 3 can be understood to be a passive actuator because it has no motor or other drive unit. It functions only in connection with an active actuator, which is an electric, hydraulic, or pneumatic motor, for example. The active actuator, not shown, controls and triggers the passive actuator, which is coupled for example via the gear 22 to the electric or other motor, not shown, that constitutes the active actuator or is a component of an active actuator. Other couplings, for example also with a rack-and-pinion transmission, are also possible.

The actuators 10 from FIGS. 2 and 3 can also be used as a (rotation) damper with variable damping. A rotating drive of the spindle 2 is damped in that the electric motor 13 is operated as a generator and brakes, i.e. damps, the rotation of the spindle 2. A so-called four-quadrant operation of the electric motor 13 is also possible, in which the electric motor is operated as a motor or as a generator, depending on the situation. By controlling or regulating the generator output of the electric motor 13, it is possible to adjust the magnitude of the braking moment of the electric motor 13 and therefore the magnitude of the damping, i.e. it is possible to vary the damping of the actuator 10 being used as a damper. A damping action is also possible with a brake 32 of the kind that is described below in conjunction with FIG. 2.

With the sliding motion of the counterpart component 4, the helical compression spring 18 that constitutes the spring element 17 is prestressed to a greater degree, thus storing energy that it subsequently outputs with the next extension of the counterpart component 4. The actuator 10 consequently functions as an energy storage mechanism. The energy storage in the spring element 17 also contributes to the possibility of using a less powerful electric motor 13, hydraulic motor, hydraulic cylinder, or other drive unit.

FIG. 4 shows the developed view of a possible convolution 5 of the thread 3 of a helical gearing 1 according to the invention as shown in FIGS. 1 through 3. The axial direction of the spindle 2, not shown in FIG. 4, is vertical in FIG. 4 and the radial direction relative to the spindle 2 is therefore horizontal. As is clear from the drawing, the convolution 5 has radial sections 29, 30 at the beginning and end. In these sections, the thread 3 is self-locking; it prevents the counterpart component 4, not shown in FIG. 4, from executing an axial sliding motion without requiring a moment to be exerted on the spindle 2. FIG. 4 shows the shaft stub 7 of the counterpart component 4 and the roller 8 mounted thereon in different positions of the convolution 5. As shown in the drawing, the radial sections 29, 30 of the convolution 5 can be equipped with a recess 31 into which the roller 8 snaps, so to speak, and fixes the screw drive in this position.

In the region between the radial sections 29, 30, the convolution 5 has a steadily increasing pitch. This is not absolutely required; the pitch of the convolution 5 can also decrease again; it is even possible for there to be sections with a negative pitch in which the movement direction of the counterpart component 4 would reverse (not shown). As is readily apparent from FIG. 4, it is possible to select almost any pitch of the thread 3 or of its convolutions 5 in order to achieve a desired multiplication of the helical gearing 1 at any location on the spindle 2.

The actuator 10 constitutes a subassembly with the helical gearing 1 and the electric motor 13 functioning as the drive motor or in FIG. 3, constitutes a subassembly with only the helical gearing 1 and without the drive motor.

The actuator 10 has a brake 32 with which the motor shaft 12 and the spindle 2 and therefore the actuator 10 as a whole can be immobilized. It can be a brake 32 that is applied in its position of repose and must be actuated in order to be released. In this case, the brake 32 must be released when the actuator 10 is to be actuated. A magnetic brake 32 is symbolically depicted in FIG. 2, which for example is without current and stable in the applied state. It is also possible to use a bistable magnetic brake or other brake that is without current both in the applied position and in the released position and only needs to be actuated or supplied with current when switching, i.e. when being released and when being applied.

1-12. (canceled)

13. A helical gearing, having a thread and having a counterpart component that engages the thread, in which helical gearing the thread is able to rotate relative to the counterpart component so that a rotary motion of the thread relative to the counterpart component causes a sliding motion of the counterpart component relative to the thread, wherein the thread has a changing pitch.

14. The helical gearing as recited in claim 13, wherein the counterpart component has a rolling element that rolls along a thread flank of the thread.

15. The helical gearing as recited in claim 13, wherein the thread is a multi-start thread.

16. The helical gearing as recited in claim 15, wherein the counterpart component has a rolling element for each convolution of the multi-start thread.

17. The helical gearing as recited in claim 13, wherein the helical gearing has a spring element, which is deformed with a sliding motion of the counterpart component relative to the thread, and the pitch of the thread increases as a spring force of the spring element decreases due to a deforming of the spring element.

18. The helical gearing as recited in claim 13, wherein the thread has no pitch in some locations.

19. The helical gearing as recited in claim 17, wherein the thread has a constant pitch.

20. The helical gearing as recited in claim 17, wherein the helical gearing constitutes a subassembly.

21. The helical gearing as recited in claim 13, wherein the helical gearing has a drive motor.

22. The helical gearing as recited in claim 13, wherein the helical gearing has a brake with which the thread can be immobilized with the counterpart component.

23. The helical gearing as recited in claim 21, wherein the helical gearing has a spring element which, with a sliding motion of the counterpart component relative to the thread in one direction of a working stroke, relaxes and outputs energy in addition to the drive motor and with a sliding motion of the counterpart component relative to the thread in an opposite direction of a return stroke, is placed under stress by the drive motor via the helical gearing assisted by an external load, provided that an external load is acting on the thread or the counterpart component in the direction of the return stroke.

24. The helical gearing as recited in claim 13, wherein the helical gearing has a spring element that is deformed with a sliding motion of the counterpart component relative to the thread; the helical gearing has a drive motor; and the helical gearing is used as a variable damper.
